(19) United States
(12) Patent Application Publication
(10) Pub. No.: US 2007/0018145 A1
(43) Pub. Date: Jan. 25, 2007

(54) Electrical and manual dual purpose jack lift

(76) Inventor: Kuo-Liang Wang, Taichung County (TW)

Correspondence Address: BIRCH STEWART KOLASCH & BIRCH, PO BOX 747, FALLS CHURCH, VA, 22040-0747, US

(21) Appl. No.: 11/183,735

(22) Filed: Jul. 19, 2005

(51) Int. Cl. B66F 3/00

(52) U.S. Cl. 254/126

(57) ABSTRACT

An electrical and manual dual purpose jack lift includes a base, a pair of lower bracing arms having a first end hinged on the left side and right side of the base, a connection member located above the base, a pair of upper bracing arms having a first end hinged on the left side and right side of the connection member, and a screw bar having a tail end fastened to an axle. The upper and lower bracing arms have second ends hinged on the axle and an anchor axle. The screw bar has a head end running through the anchor axle. The head end of the screw bar is movably coupled. The screw bar has a distal end coupled with an elastic element which pushes the axle to fasten to the screw bar and prevents the upper and lower bracing arms from hitting each other to avoid damage.

### FIELD OF THE INVENTION

The present invention relates to a jack lift and particularly to an electrical and manual dual purpose jack lift that has a detachable driving motor.

### BACKGROUND OF THE INVENTION

The small and portable jack lift is a common tool in vehicles. In some situations, such as the tire is flatted, it can be used to raise the chassis of the vehicle and replace the flatted tire with a backup tire. Lifting or lowering of the jack lift is accomplished by rotating a screw bar to drive a pair of upper and lower bracing arms upwards or downwards. In the conventional manual jack lift the screw bar is rotated by human labor. It takes a lot of time and effort. User often has to squat on the ground for a long period of time to rotate the screw bar, and the upper and lower bracing bars are raised or lowered at a very low speed. It is not very practical. Hence electrical jack lift has been developed. It mainly has a motor on one end to drive and rotate the screw bar so that lifting or lowering can be done quickly. While it resolves the problem of slow lifting and lowering speed of the manual jack lift, it is useless if the motor malfunctions or electric power is not available. There is still room for improvement.

### SUMMARY OF THE INVENTION

Therefore the primary object of the invention is to provide an electrical and manual dual purpose jack lift that includes a base, a pair of lower bracing arms which have a first end hinged on the left side and right side of the base, a connection member located above the base, a pair of upper bracing arms with a first end hinged on the left side and right side of the connection member, and a screw bar which has a tail end screwed on an axle. The upper and lower bracing arms have a second end on the left side and right side to be hinged on the axle and an anchor axle. The screw bar has a head end running through the anchor axle and movably coupling with a driving shaft of a driving source. The driving shaft has a hub to engage with a coupling member on an outer side of the anchor axle. The jack lift thus constructed may be driven electrically and manually. The screw bar has a distal end coupled with an elastic element which pushes the axle and the screw bar to form a screwing condition and prevent the upper and lower bracing arms from folding and hitting each other to avoid damage.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a first embodiment of the present invention.

FIG. 2A is a sectional view of the first embodiment of present invention.

FIG. 2B is a cross section taken on line 2B-2B in FIG. 2A.

FIG. 3 is a fragmentary perspective view of the first embodiment of present invention.

FIG. 4A is a sectional view of a second embodiment of the present invention showing a screw bar coupled with a driving source.

FIG. 4B is a perspective view of a coupling member.

FIG. 5A is a perspective view of a third embodiment of the present invention showing the screw bar coupled with the driving source.

FIG. 5B is a cross section taken on line 5B-5B in FIG. 5A.

FIG. 6 is a cross section of a fourth embodiment of the present invention showing the screw bar coupled with the driving source.

FIG. 7A is an exploded view of a fifth embodiment of the present invention showing the screw bar coupled with the driving source.

FIG. 7B is a sectional view according to FIG. 7A.

FIG. 8 is a perspective view of a sixth embodiment of the present invention showing the screw bar coupled with the driving source.

### DETAILED DESCRIPTION OF THE PREFERRED EMBODIMENTS

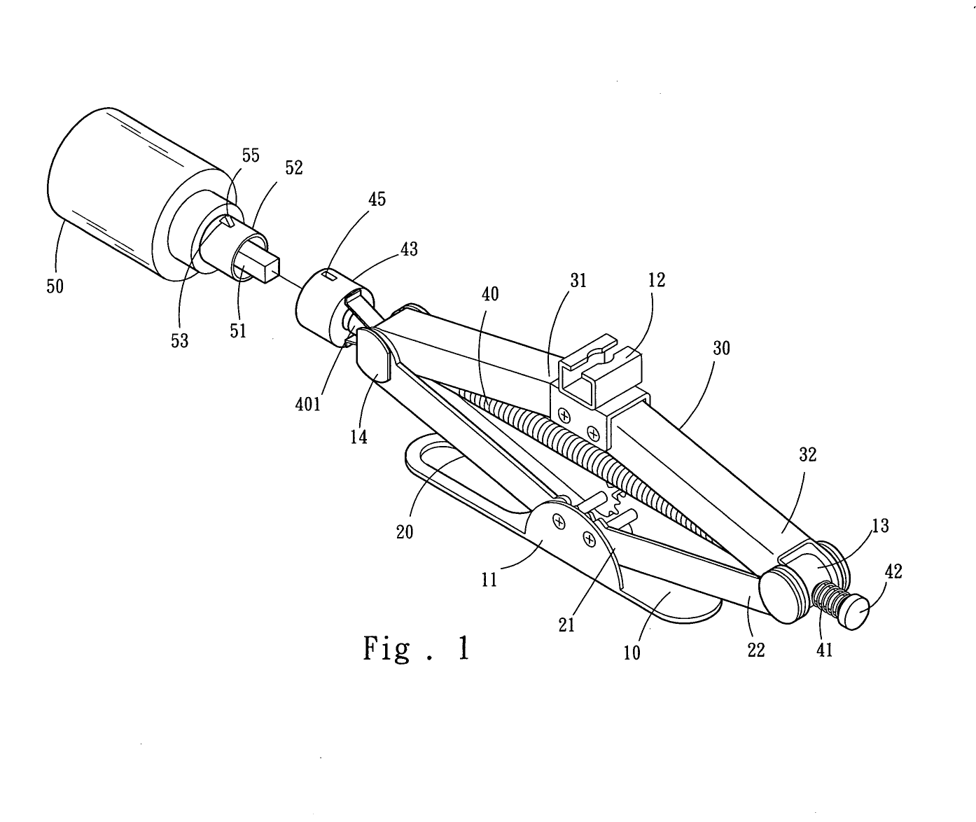

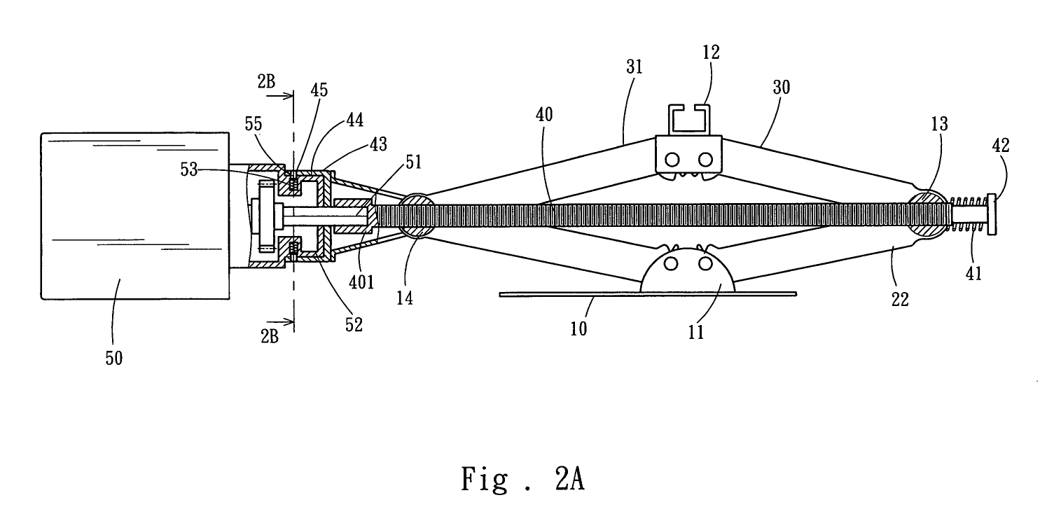

Please referring to FIGS. 1 and 2A, the electrical and manual dual purpose jack lift according to the invention includes a base 10 resting on the ground that has a pair of lugs 11 on an upper side, a pair of lower bracing arms 20 which have first ends 21 hinged on the lugs 11, a rectangular connection member 12 located on above the base 10, a pair of upper bracing arms 30 which have first ends 31 hinged on the left side and right side of the connection member, a round axle 13 to hinge second ends 32 on one side of the upper and lower bracing arms 30 and 20, and an anchor axle 14 on another side corresponding to the axle 13 to be hinged by second ends 32 and 22 on another side of the upper and lower bracing arms 30 and 20. There is a screw bar 40 with a head end transversely running through the anchor axle 14 and a tail end fastened to the axle 13. The screw bar 40 can be rotated to drive the axle 13 to move inwards or outwards along the screw bar 40. The tail end of the screw bar 40 is smaller than the outer diameter of the screw bar 40 and runs through an axial elastic element 41 (such as a spring) which is extendable. The tail end of the screw bar 40 has a detent flange 42 to hold one end of the elastic element 41. The elastic element 41 has other end pressing the axle 13 on an outer side. The head end of the screw bar 40 has a hollow and polygonal coupling head 401. There is a driving source 50 (such as a motor) which has an extended driving shaft 51 with a distal end formed in a polygonal strut. The driving shaft 51 has a tail end to engage with the coupling head 401 of the screw bar 40.

By means of the aforesaid construction, when the driving source 50 is activated, it can drive the screw bar 40 to rotate. The axle 13 fastened to the screw bar 40 is moved inwards along the screw bar 40. The upper and lower bracing arms 30 and 20 hinged on the axle 13 and the anchor axle 14 can be unfolded or folded to move the connection member 12 upwards or downwards thereby to lift an object.

During lowering the connection member 12, in order to prevent the driving source 50 from driving the screw bar 40 endlessly, and resulting in the upper and lower bracing arms 30 and 20 moving and hitting each other and causing damage, the length of the screw bar 40 is limited. Moreover, the elastic element 41 on the tail end of the screw bar 40 provides an elastic force to prevent the upper and lower bracing arms 30 and 20 from moving outwards and folding and hitting each other, and causing damage. When the tail end of the screw bar 40 escapes from the screw hole of the axle 13, an idle rotation occurs so that the upper and lower bracing arms 30 and 20 are not moved close to each other. When the screw bar 40 is rotated in the reverse direction, the axle 13 is engaged with the screw bar 40 again and moved inwards.

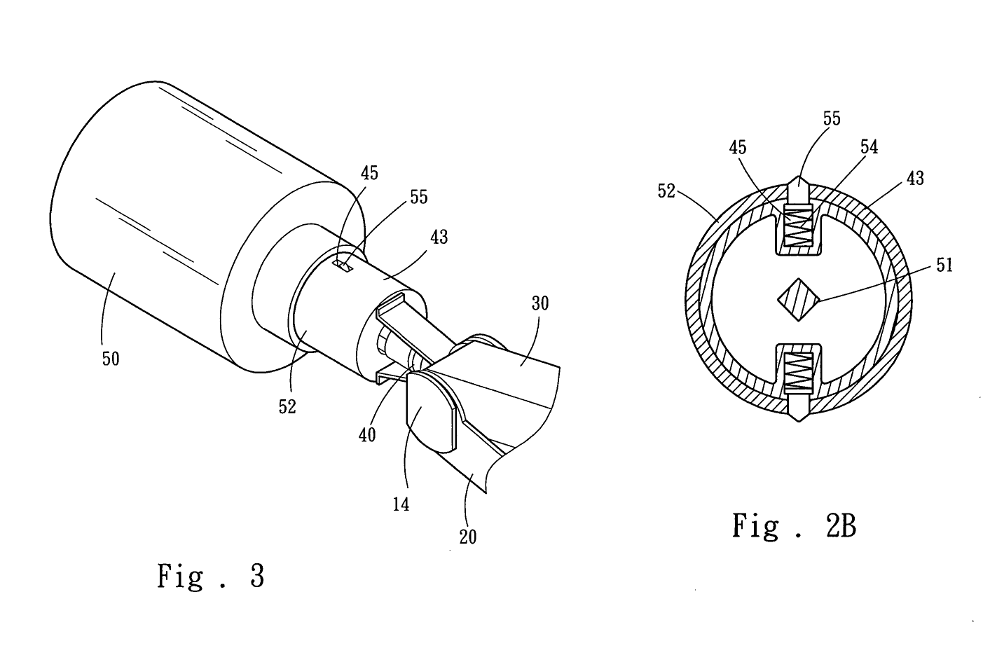

Refer to FIGS. 1 and 2B for a first embodiment of coupling of the screw bar 40 and the driving source 50. The driving shaft 51 is encased by a hollow hub 52 which has a pair of cavities 53 on the peripheral wall of a distal end to hold an elastic element 54 (such as a spring) that is extendable axially. The elastic element 54 is coupled with a pin 55 on an outer side. The pin 55 has one end retained by an outer edge of the cavity 53 so that the pin 55 is pushed by the elastic element 54 and has another end extended outside the outer wall of the hub 52. The anchor axle 14 has a hollow coupling member 43 on an outer side with a recess 44 formed on one end. The recess 44 can be coupled with one end of the hub 52. The recess 44 has a pair of apertures 45 on the peripheral wall to receive the pin 55 so that the coupling member 43 can be coupled and latched with the hub 52 of the driving source 50 as shown in FIG. 3. In the event that the driving source 50 malfunctions, depressing the two pins 55 at the same time, the hub 52 may be detached from the coupling member 43, and the driving shaft 51 can be separated from the coupling head 401 of the screw bar 40. Therefore, the screw bar 40 can be driven and rotated manually to control raising and lowering of the upper and lower bracing arms 30 and 20.

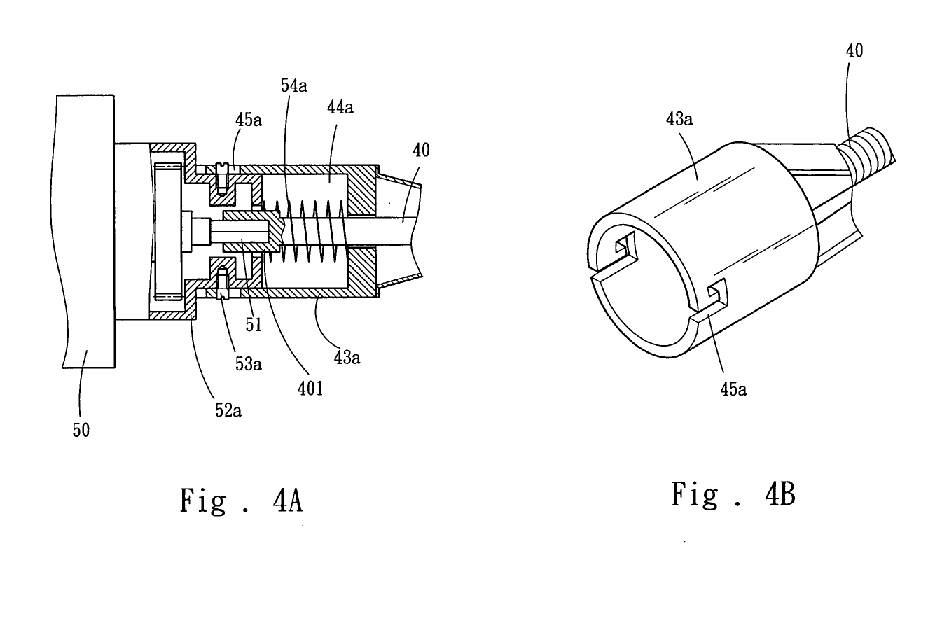

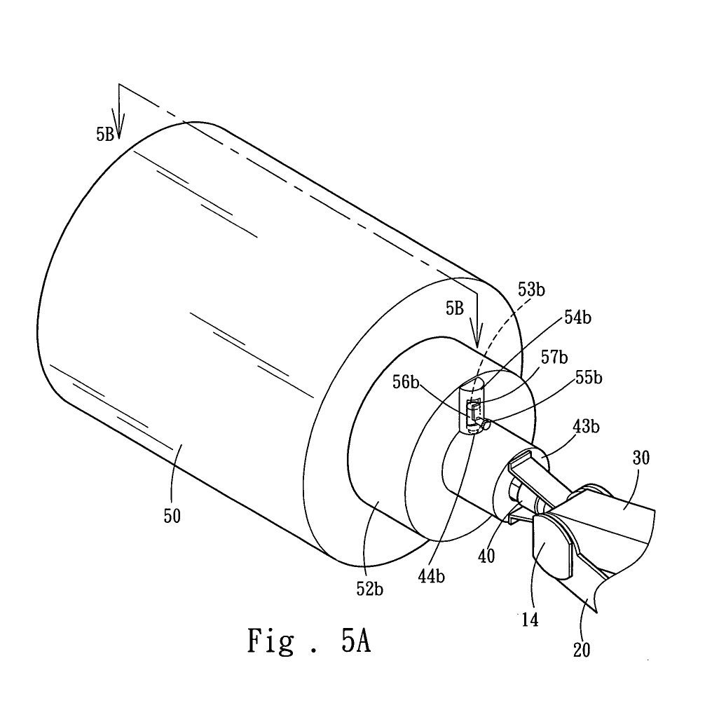

Refer to FIGS. 4A and 4B for a second embodiment of coupling of the screw bar 40 and the driving source 50. The driving shaft 51 is encased by a hollow hub 52a which can be rotated freely. The hub 52a has a distal end with the peripheral wall embedded with a pair of struts 53a on two opposing sides. The anchor axle 14 has a coupling member 43a facing the driving source 50. The coupling member 43a has a recess 44a on one end. The recess 44a can be coupled with a distal end of the hub 52a. The recess 44a holds an elastic element 54a which is extendable axially to push the hub 52a outwards, and two hook-like wedge slots 45a on the peripheral wall movable to mate the movement of the struts 53a. The hub 52a can be engaged with the coupling member 43a and turned for a selected angle. When the turning is stopped and user's hand is released, the hub 52a is pushed by the elastic force of the elastic element 54a and the strut 53a is latched on the hook portion of the wedge slot 45a. Hence the coupling member 43a on the outer side of the anchor axle 14 is coupled with the hub 52a of the driving source 50. When the driving source 50 malfunctions, turn the hub 52a with hands to disengage the wedge slot 45a from the struts 53a, then the coupling member 43a can be separated from the driving source 50.

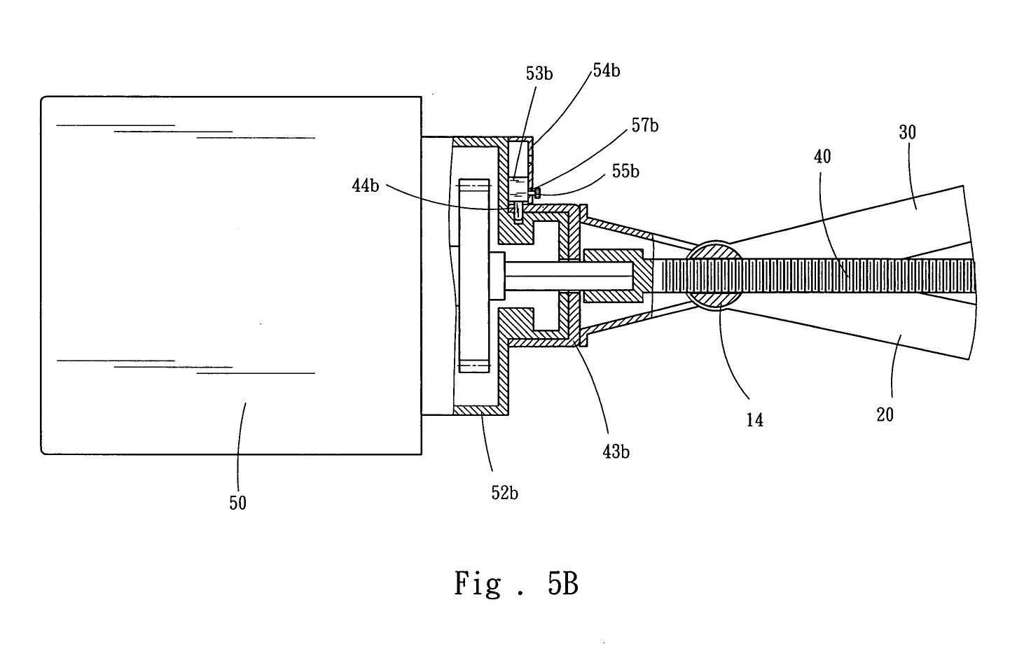

Refer to FIGS. 5A and 5B for a third embodiment of coupling of the screw bar 40 and the driving source 50. The driving shaft 51 is encased by a hollow hub 52b which has a latch strut 53b movable up and down on one end surface thereof. There is a hollow latch duct 54b located on the end surface of the hub 52b to encase the latch strut 53b. The latch strut 53b has a transverse detent bar 55b extended outside which is movable up and down along a guiding trough 56b formed on the wall of the latch duct 54b. The guiding trough 56b has respectively a transverse straddle trough 57b on an upper and lower side of one side to retain and anchor the detent bar 55b. The anchor axle 14 has a hollow coupling member 43b on an outer side with an insertion hole 44b formed on the outer wall to receive a distal end of the latch strut 53b so that the screw bar 40 and the driving shaft 51 of the driving source 50 can be coupled together. And the hub 52b on the outer side of the driving shaft 51 can be engaged with the coupling member 43b on the outer side of the anchor axle 14. For detachment, raise the detent bar 55b to move the latch strut 53b away from the insertion hole 44b of the coupling member 43b, the hub 52b can be detached from the coupling member 43b.

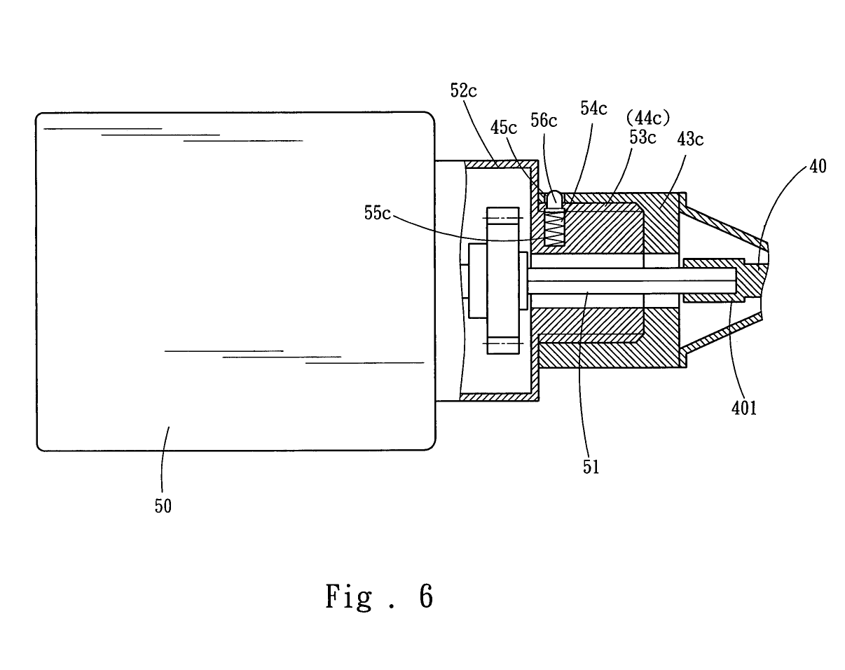

Refer to FIG. 6 for a fourth embodiment of coupling of the screw bar 40 and the driving source 50. The driving shaft 51 is encased by a hollow hub 52c which can be rotated freely. The hollow hub 52c has a distal end formed a screw thread portion 53c and a cavity 54c on the peripheral wall to hold an elastic element 55c and a pin 56c. The pin 56c has one end retained by the outer edge of the cavity 54c and is pushed by the elastic element 55c so that another end thereof is extended outside. The anchor axle 14 has an outer side coupled with a hollow coupling member 43c which has a screw hole 44c in the interior. The screw hole 44c can be fastened with the screw thread portion 53c of the hub 52c. There is an aperture 45c around the screw hole 44c to be wedged by the pin 56c. Thus, when the driving source 50 malfunctions, the pin 56c can be depressed, and the hub 52c can be turned and separated from the coupling member 43c to disengage the driving shaft 51 from the screw bar 40.

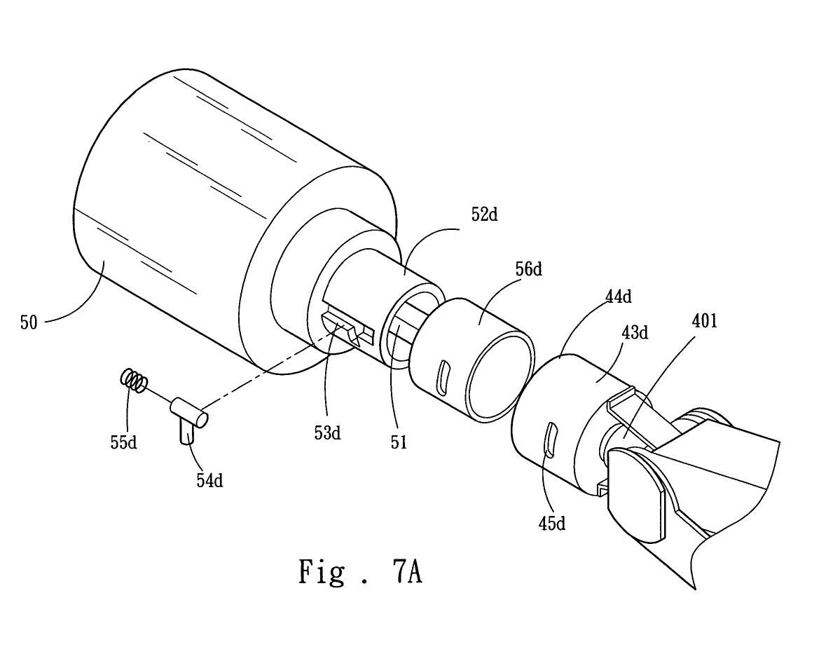

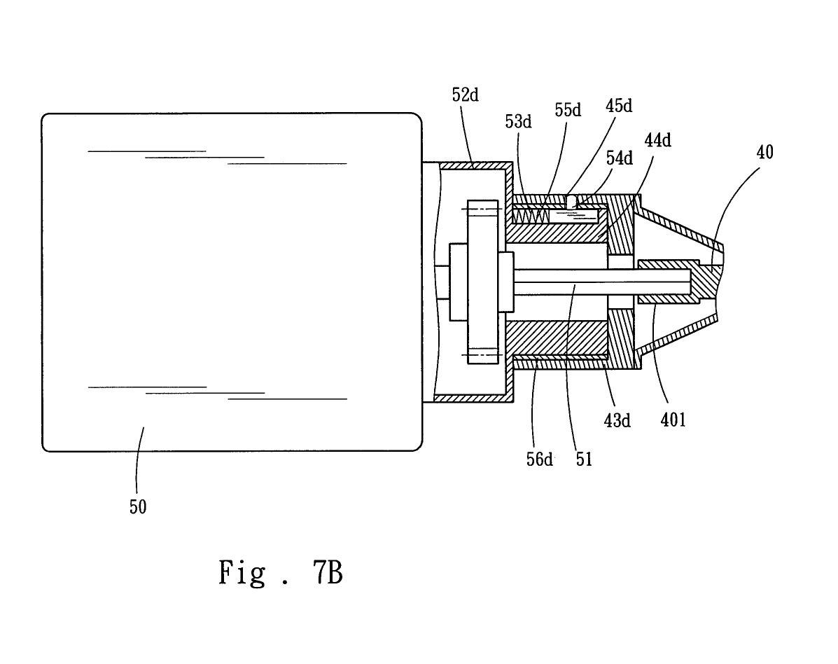

Refer to FIGS. 7A and 7B for a fifth embodiment of coupling of the screw bar 40 and the driving source 50. The driving shaft 51 is encased by a hollow hub 52d which has an axial T-shaped wedge slot 53d on the outer wall of a distal end thereof. There is a T-shaped pin 54d embedded in the T-shaped wedge slot 53d. The pin 54d is pushed outwards by an elastic element 55d located in the wedge slot 53d. A coupling duct 56d is provided to couple the hub 52d to anchor the pin 54d and the elastic element 55d. The anchor axle 14 has a hollow coupling member 43d on an outer side. The coupling member 43d has a recess 44d on one end to engage with a distal end of the hub 52d. The coupling member 43d has a radial slot 45d on an outer wall to be latched by the pin 54d located in the wedge slot 53d. Hence the coupling member 43d can be coupled with the hub 52d together. When the pin 54d is turned and fully embedded in the wedge slot 53d, the coupling member 43d can be separated from the hub 52d.

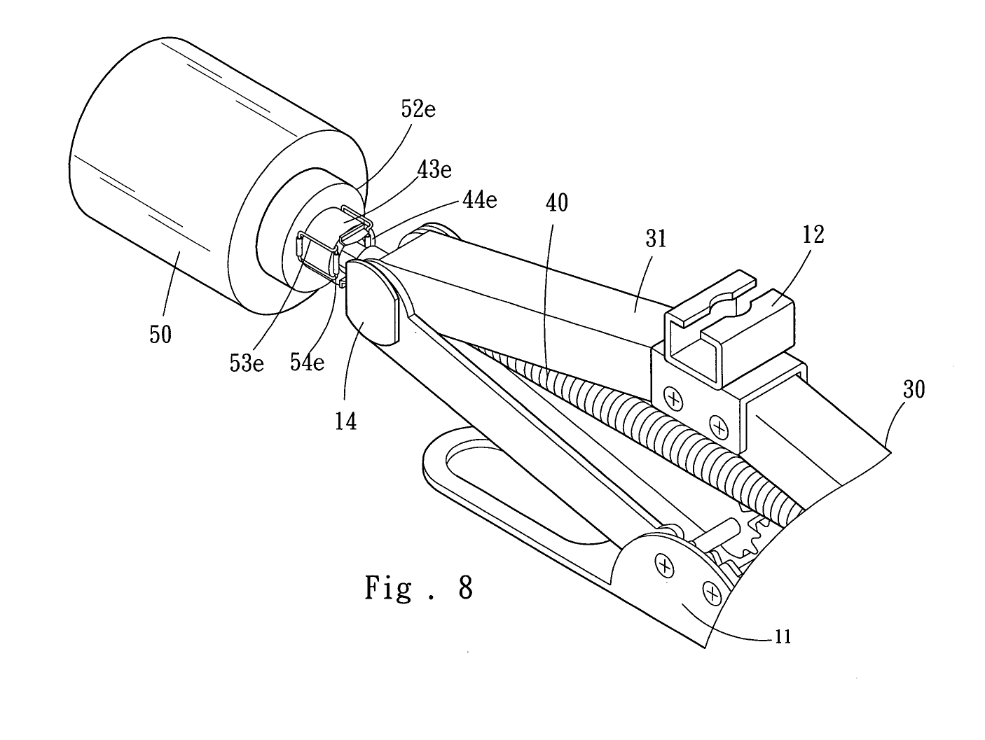

Refer to FIG. 8 for a sixth embodiment of coupling of the screw bar 40 and the driving source 50. The driving shaft 51 is encased by a hollow hub 52e which has one end pivotally coupled with a pair of hook-like latch clips 53e on two opposite sides. The latch clips 53e have one end swivelable inwards and outwards. The latch clips 53e have a distal end formed a latch lug 54e directing inwards. The anchor axle 14 has a hollow coupling member 43e on an outer side. The coupling member 43e has a radial detent wall 44e on an outer side to engage with the latch lug 54e for anchoring. Thus the hub 52e can be engaged with the coupling member 43e together. When the driving source 50 malfunctions, the latch clips 53e can be moved outwards to rapidly disengage the coupling member 43e so that the driving shaft 51 can be detached from the screw bar 40.

In summary, compared with the conventional jack lift, the invention provides two advantages: first, when the upper and lower bracing arms 30 and 20 are driven electrically lower, the elastic element 41 on the distal end of the screw bar 40 can prevent the screw bar 40 from rotating endlessly. Hence hitting and damage of the upper and lower bracing arms 30 and 20 can be avoided. Second, when the axle 13 has been separated from the screw bar 40, if the screw bar 40 is driven and rotated again, the elastic member 41 can push the axle 13 to engage with the screw bar 40. Moreover, the driving source 50 can be removed whenever desired. Thus in the event that the driving source 50 malfunctions or electric power is not available, the screw bar 40 can be driven manually to raise or lower the jack lift.

Furthermore, having described the invention in connection with certain specific embodiments thereof, it is to be understood that further modifications may now suggest themselves to those skilled in the art, it is intended to cover all such modifications as fall within the scope of the appended claims.

What is claimed is:

1. An electrical and manual dual purpose jack lift, comprising:
a base;
a pair of lower bracing arms which have a first end hinged on a left side and a right side of the base;
a connection member located above the base;
a pair of upper bracing arms which have a first end hinged on a left side and a right side of the connection member;
a screw bar which has a tail end fastened to an axle;
wherein the upper and the lower bracing arms have respectively second ends hinged on the axle and an anchor axle, the screw bar having a head end running through the anchor axle to be coupled with a driving shaft extended from a driving source; and
wherein the driving shaft has a hub on the periphery which has an outer wall coupled with at least one pin extendable inwards and outwards, the anchor axle having a coupling member on an outer side, the coupling member having a recess on one end facing the driving source, the recess being coupled with a distal end of the hub and having at least one aperture to receive the pin.

2. The electrical and manual dual purpose jack lift of claim 1, wherein the tail end of the screw bar is smaller than the diameter of the screw bar and runs through an elastic element which is extendable axially, the tail end having a detent flange to press one end of the elastic element which has another end pressing the axle.

3. The electrical and manual dual purpose jack lift of claim 1, wherein the driving shaft of the driving source has a distal end formed in a polygonal strut, the head end of the screw bar having a coupling head formed with a polygonal cavity to be engaged with the distal end of the driving shaft.

4. The electrical and manual dual purpose jack lift of claim 1, wherein the hub has two struts on the outer wall at two opposing sides, and is engaged with a coupling member, the coupling member having a recess on one end to house an elastic element which is extendable axially, the recess being coupled with the distal end of the hub, the recess having a pair of hook-shaped wedge slots on the outer wall to be wedged in by the struts on the outer wall of the hub on a hook portion of the wedge slots for anchoring.

5. The electrical and manual dual purpose jack lift of claim 1, wherein the hub on the outer side of the driving shaft has a latch strut movable up and down on one end thereof, the latch strut being housed in a latch duct and having a transverse bar, the latch duct being located on an end surface of the hub and having a longitudinal guiding trough, the guiding trough having two straddle troughs on an upper side and a lower side of one side thereof, the straddle troughs holding the detent bar, the coupling member of the anchor axle having an insertion hole on the peripheral wall to receive the latch strut.

6. The electrical and manual dual purpose jack lift of claim 1, wherein the hub has a screw thread portion on the distal end and is turnable and has a pin extendable elastically through the outer wall thereof, the coupling member of the anchor axle having a screw hole to engage with the screw thread portion, the screw hole having an aperture to receive the pin.

7. The electrical and manual dual purpose jack lift of claim 1, wherein the hub on the outer side of the driving shaft has a T-shaped wedge slot on the peripheral wall to be embedded with a T-shaped pin, the pin being pushed by an elastic element located in the wedge slot, the hub being encased by a coupling duct, the coupling member on the outer side of the anchor axle having a slot on the peripheral wall to allow the pin to be moved upwards and turned for latching.

8. The electrical and manual dual purpose jack lift of claim 1, wherein the hub on the outer side of the driving shaft has two latch clips on two opposite sides, the latch clips having one end hinged on an end surface of the hub and another end formed a latch lug directing inwards, the coupling member having a radial detent wall on the periphery to be latched by the latch lug.
